(19) United States
(12) Patent Application Publication
(10) Pub. No.: US 2022/0119114 A1
(43) Pub. Date: Apr. 21, 2022

(54) Multipurpose Aerial Sprinkler System

(71) Applicant: Juan Manuel Moreno, Concord, CA (US)

(72) Inventor: Juan Manuel Moreno, Concord, CA (US)

(21) Appl. No.: 17/502,204

(22) Filed: Oct. 15, 2021

Related U.S. Application Data
(60) Provisional application No. 63/092,823, filed on Oct. 16, 2020.

(51) Int. Cl. B64D 1/18; A62C 3/02

(52) U.S. Cl. CPC B64D 1/18; A62C 3/0242

(57) ABSTRACT

The present invention relates to a multipurpose water/fire suppressant sprinkler system designed to be attached to an aerial vehicle such as a helicopter or firefighter plane. The multipurpose sprinkler system features a plurality of concentric tubes or, alternatively, a single spiral tube. The plurality of concentric tubes or single spiral tube each further comprise a plurality of sprinkler heads in fluid communication with a material holding tank, wherein water or a fire suppressant material in the material holding tank is selectively discharged from the tank through the plurality of sprinkler heads. The flow of water or the fire suppressant material can be controlled through a valve connected to the system.

### CROSS-REFERENCE TO RELATED APPLICATION

The present application claims priority to, and the benefit of, U.S. Provisional Application No. 63/092,823, which was filed on Oct. 16, 2020 and is incorporated herein by reference in its entirety.

### FIELD OF THE INVENTION

The present invention relates generally to the field of water application and fire suppressant systems. More specifically, the present invention relates to a multipurpose sprinkler system attached on the bottom of a helicopter which can be used to put out widespread large fires, such as forest fires. The sprinkler system features a plurality of sprinkler heads in fluid communication with a water or other fire-suppressant tank housed within, or attached to, an aerial vehicle, such as a helicopter. The system further comprises a valve for controlling the flow of water or another fire-suppressant material from the tank to the plurality of sprinkler heads, and a harness for firmly securing the sprinkler system to the aerial vehicle. The sprinkler system of the present invention enables firefighters to effectively combat forest and field fires. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, a common hazard in forests is forest fires. The threat of forest fires, field fires and other widespread, large fire disasters has existed for a long period of time. Forest fires result in loss of forest wealth, flora and fauna, which seriously disturbs the biodiversity and the environment. Regardless of its causes; once a forest fire starts, it can spread quickly, causing massive loss to life and property. Currently, firefighters have a number of fire-suppression techniques that they can use to put out forest fires. These include, but are not limited to, spreading dirt or foam on a fire to cut off the oxygen supply and/or adding water or another fire-suppressant to extinguish the fire.

Currently used fire-suppression techniques can be slow and labor intensive. Depending on location, firefighters may lack the resources and devices to extinguish a fire. Even when resources are available, the resources may be exhausted before a fire is totally extinguished. In either case, the fire may grow at a rate faster than the rate at which it can be extinguished. The rate of fire growth is proportional to wind speeds, such that if the wind is strong the fires become more difficult to control.

Additionally, forest fires happen in an open ecological system; therefore, they are influenced by numerous complicating factors. One important factor in forest fires is that there may be no passable roads. The lack of roads will delay firefighters in reaching the fire, allowing the fire more time to grow and making the process of extinguishing the fire more difficult. If the forest fire has grown very large, firefighting tools such as firefighting suits are not able to withstand the heat and flames. In these situations, the conventional fire-suppression and extinguishing techniques are dangerous, and the personal safety of the firefighters is at risk.

Therefore, there exists a long-felt need in the art of fire fighting for a sprinkler system capable of putting out large forest fires, field fires and other widespread and large fire disasters that cannot be effectively addressed with conventional fire-suppression and extinguishing techniques. There exists a long-felt need in the art for a sprinkler system to combat and control large, devastating fires before they devastate the environment, destroy property and endanger lives. Moreover, there exists a long-felt need in the art for a sprinkler system with a greater range of deployment, that allows firefighters to quickly put out forest fires. Further, there exists a long-felt need in the art for a sprinkler system that ensures the safety of firefighters, and that ensures appropriate resources are present to put out large widespread fires. Finally, there is a long-felt need for a forest fire-suppression system that is relatively inexpensive to manufacture, and that is both safe and easy to use.

The subject matter disclosed and claimed herein, in one embodiment thereof, comprises a multipurpose water sprinkler system designed to attach to an aerial vehicle and combat fires or assist in irrigation, comprising of a horizontal tubing system having a plurality of concentric circular tubes or a single spiral tube, a plurality of sprinkler heads acting as high-speed nozzles present on the bottom surface of the tubing system, a harness system having a plurality of harnesses connected to the top portion of the aerial vehicle and supporting the horizontal tubing system, a water tank designed to be placed inside the aerial vehicle in fluid communication with the horizontal tubing system via a connecting pipe and a valve, the water stored in the water tank flowing through the horizontal tubing system and is dispensed from the plurality of sprinkler heads to the ground uniformly and at a high volume. The valve controls the flow of the water flowing through the connecting pipe.

In this manner, the multipurpose sprinkler system of the present invention accomplishes all the forgoing objectives, thereby enabling the firefighters to combat and control fire in a large area such as, a large forest fire, a field fire or other widespread large fire disasters. The multipurpose sprinkler system ensures the safety of the firefighters, while allowing them to safely and effectively extinguish forest fires, thereby saving lives and property.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose water sprinkler system designed to attach to an aerial vehicle and combat fires or assist in irrigation, comprising of a horizontal tubing system having a plurality of concentric circular tubes or a single spiral tube, a plurality of sprinkler heads acting as high speed nozzles present on the bottom surface of the tubing system, a harness system having a plurality of harnesses connected to top portion of the aerial vehicle and supporting the horizontal tubing system, a water tank designed to be placed inside the aerial vehicle and that is in fluid communication with the horizontal tubing system via a connecting pipe and a valve, the water stored in the water tank flows through the horizontal tubing system and is dispensed from the plurality of sprinkler heads to the ground uniformly and at a high volume. The valve controls the flow of the water flowing through the connecting pipe.

In a further embodiment of the present invention, a firefighting water spraying apparatus is disclosed, comprising of a water storage tank, a sprinkler tube system, a plurality of high-volume water spraying heads supported on the sprinkler tube system, wherein direction of the high-volume water spraying heads can be changed relative to the sprinkler tube system, and the water storage tank and the sprinkler tube system is in fluid communication through a connecting pipe and a valve wherein the valve controls the flow of water from the water storage tank. The firefighting water spraying apparatus is supported using a plurality of harnesses which are attached to the top portion of an aerial vehicle.

In yet a further embodiment of the present invention, a multipurpose water sprinkler system for effectively combating forest and field fires and providing irrigation services to a very large area is disclosed, and is comprised of a water sprinkler system that can be installed on an elevated stationary support or the bottom of an aerial vehicle, the water sprinkler system having either a plurality of concentric connected circular tubes or a single spiral tube and having a plurality of high volume water releasing sprinkler heads, and a water storage tank. The water storage tank and the water sprinkler system are in fluid communication through a connecting pipe and a valve wherein the valve controls the flow of water from the water storage tank. A water pressure gauge allows a user to view the water pressure and the valve allows the water pressure to increase or decrease.

To the accomplishment of the foregoing and related ends, certain illustrative aspects of the disclosed innovation are described herein in connection with the following description and the annexed drawings. These aspects are indicative of only a few of the many ways in which the principles disclosed herein can be employed and are not intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which like reference numerals refer to like parts throughout the different views, and in which:

FIG. 1 illustrates a perspective view of one potential embodiment of a multipurpose water sprinkler system of the present invention attached to an aerial vehicle or helicopter in accordance with the disclosed architecture;

FIG. 2 illustrates a close-up perspective view of one potential embodiment of a sprinkler head of the multipurpose water sprinkler system of the present invention, wherein the sprinkler head is designed to dispense water or other fire-suppressant materials on a fire in accordance with the disclosed architecture;

FIG. 3 illustrates a side perspective view of an aerial vehicle transporting one potential embodiment of the multipurpose water sprinkler system of the present invention in accordance with the disclosed architecture; and

FIG. 4 illustrates a front perspective view of another embodiment of the multipurpose water sprinkler system of the present invention in accordance with the disclosed architecture, wherein the system comprises a spiral sprinkler design.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It can be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there is a long-felt need in the art for a sprinkler system to combat and control large, devastating fires before they devastate the environment, destroy property and endanger lives. There is also a long-felt need in the art for a sprinkler system capable of putting out large forest fires, field fires and other large, widespread fire disasters that cannot be effectively addressed with conventional fire-suppression and extinguishing techniques. Moreover, there exists a long-felt need in the art for a sprinkler system with a greater range of deployment that allows firefighters to quickly put out forest fires. Further, there exists a long-felt need in the art for a sprinkler system that ensures the safety of firefighters, and that ensures appropriate resources are present to put out large widespread fires. Finally, there is a long-felt need for a forest fire-suppression system that is relatively inexpensive to manufacture, and that is both safe and easy to use.

The present invention, in one exemplary embodiment, is a novel multipurpose water sprinkler system designed to attach to an aerial vehicle and combat fires or assist in irrigation, comprising of a horizontal tubing system having a plurality of concentric circular tubes or a single spiral tube, a plurality of sprinkler heads acting as high-speed nozzles present on the bottom surface of the tubing system, a harness system having a plurality of harnesses connected to the top portion of the aerial vehicle and supporting the horizontal tubing system and a water tank designed to be placed inside the aerial vehicle. The tank is in fluid communication with the horizontal tubing system via a connecting pipe and a valve, the water stored in the water tank flows through the horizontal tubing system and is dispensed from the plurality of sprinkler heads to the ground uniformly and at a high volume. The valve controls the flow of the water flowing through the connecting pipe.

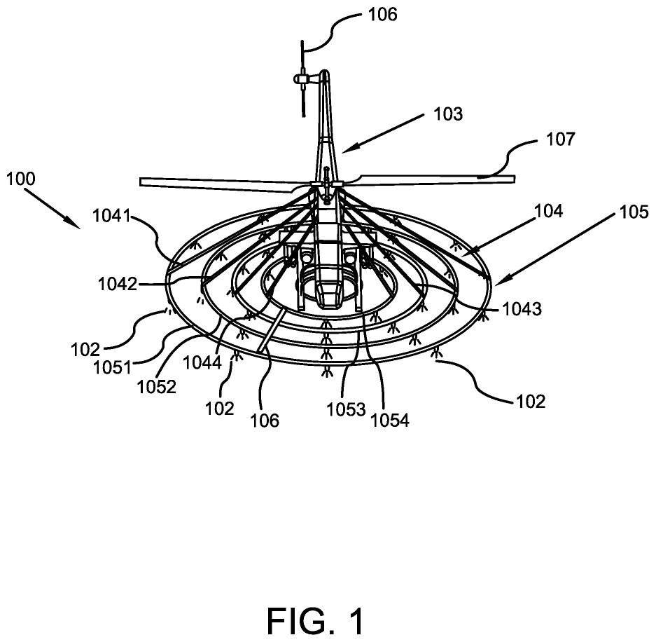

Referring initially to the drawings, FIG. 1 illustrates a perspective view of one potential embodiment of a multipurpose sprinkler system 100 of the present invention attached to an aerial vehicle or helicopter 103 in accordance with the disclosed architecture. As shown, the sprinkler system 100 is a multipurpose sprinkler system designed to dispense water or other fire suppression materials over a very large area so as to put out a forest fire, field fire or other type of fire. The sprinkler system 100 enables the aerial vehicles, such as helicopters, firefighter planes or the like, to combat and control large, devastating fires in a safer and more effective manner.

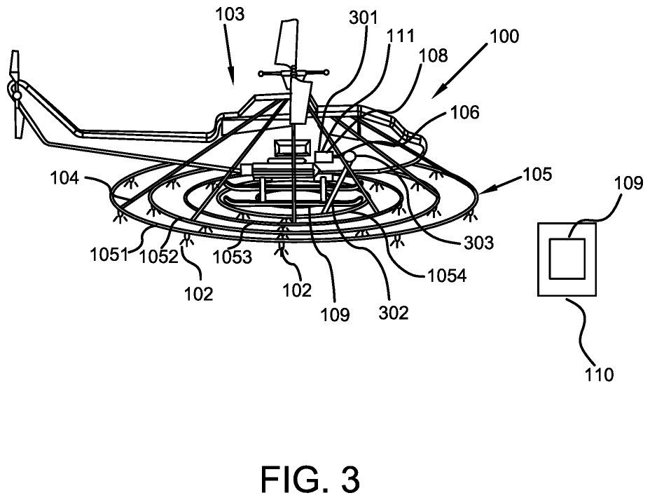

The sprinkler system 100 includes a liquid sprinkling tube system 105, a harness system 104 and a plurality of sprinkler heads 102 on each circular tube of the sprinkling tube system 105. Each tube 1051, 1052, 1053, 1054 is preferably orientated in a substantially-concentric circular formation and is in fluid communication with a water or other fire suppression source such as a tank (shown in FIG. 3) via a plurality of supply lines or pipes that are used to deliver the water or other fire suppressant to the plurality of sprinkler heads 102 to dispense onto the fire. More specifically, in one embodiment, the sprinkling tube system 105 is comprised of a plurality of concentric circular tubes 1051, 1052, 1053, 1054, each having a plurality of sprinkler heads 102 positioned there along in spaced-apart fashion. The outermost circular tube 1051 is largest in diameter, and the diameter of the tubes decreases from the outermost circular tube 1051 to the innermost circular tube 1054 with the innermost circular tube 1054 being the smallest in diameter. Each sprinkler head 102 is of substantially the same size and shape, and has a nozzle to spray the water/fire-suppressant material being supplied by the tubes 1051, 1052, 1053, 1054.

The sprinkling tube system 105 is connected to the aerial vehicle 103 using a strong, and durable harness system 104. The harness system 104 has a plurality of harnesses, wherein at least one, and preferably two, harnesses are connected to each respective circular tube 1051, 1052, 1053, 1054. For example, the outermost circular tube 1051 is connected to the aerial vehicle 103 by the longest harness 1041. Similarly, a second circular tube 1052 is connected to the aerial vehicle 103 by a second harness 1042, and a third circular tube 1053 is connected to the aerial vehicle 103 by a third harness 1043. The innermost circular tube 1054 is connected to the aerial vehicle by the shortest harness 1044. All of the harnesses 1041, 1042, 1043, 1044 of the harness system 104 are also connected to the top of the aerial vehicle 103 through strong fasteners, but in such a way as to not unduly interfere with the operation of the aerial vehicle 103. Nonetheless, the present invention is not so limited, and the harness system 104 can be connected to any suitable position on the aerial vehicle 103, such as on a side surface or to the area where the central blades 107 attach to the aerial vehicle 103.

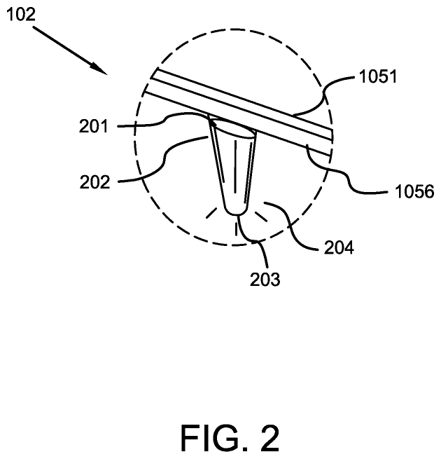

Each circular tube 1051, 1052, 1053, 1054 may also be joined to, and in fluid communication with, each other tub at one or more points through metal junctions or connecting members 106 to provide a greater balance to the water sprinkling tube system 105 while transported by the aerial vehicle 103. Further, each of circular tubes 1051, 1052, 1053, 1054 can be made of a metal such as aluminum or steel, or heavy plastic such that they remain static and stable when being transported by the aerial vehicle 103. Each of tubes 1051, 1052, 1053, 1054 should be relatively strong, durable, and resistant to fire and corrosion, and therefore may further comprise a protective coating 1056, as best shown in FIG. 2.

Water or other fire suppressant materials may be stored in a tank 301 placed within the aerial vehicle 103 as explained more fully below, and may be dispensed through the one or more sprinkler heads 102 and onto a large, widespread forest fire or other affected area. The one or more sprinkler heads 102 can be comprised of a copper, brass, chrome plating, nickel aluminium or any other suitable material for dispensing water or a fire-suppressant material. The sprinkler system 100 of the present invention can be connected to any conventional aerial vehicle 103, such as a helicopter or firefighting plane.

As stated earlier, the helicopter 103 can have a water/fire-suppressant tank 301 installed within the helicopter 103 or attached along the underside of the same. In use, the water or other fire-suppressant material is gravity fed from the tank 301 to the circular pipes 1051, 1052, 1053, 1054, which are positioned below, and are in fluid communication with, the tank 301. The water or other fire suppressant material is then dispensed through the plurality of sprinklers 102 and onto a large, widespread forest fire or other affected area. Nonetheless, it is also contemplated that the sprinkler system 100 could further comprise one or more pumps 106 that draw the water or other fire-suppressant material from the tank 301 and force the same through the circular pipes 1051, 1052, 1053, 1054 and plurality of sprinkler heads 102, as opposed to a gravity-fed system. The sprinkler system 100 enables firefighters to combat and control forest and field fires in a more effective manner.

The sprinkler system 100 of the present invention has dimensions and weight that are reasonable for any conventional firefighter plane or helicopter 103. The tube system 105, the harness system 104 and the tank 301 can come in many different sizes and weights to suit user need and/or preference or the particular aerial vehicle 301 with which the sprinkler system of the present invention 103 is being used. Further, the modular construction of the tube system 105 is such that it can also easily be adjusted to suit user need or preference, or a particular application. For example, it is contemplated that the system 100 of the present invention can also be used to deliver pesticides, fertilizers and the like to crops, fields, etc.

In one embodiment, each harness 1041, 1042, 1043, 1044 of the harness system 104 can be controlled by a control button or panel located near the operator of the aerial vehicle 103, such that each harness is loosened when the control button is activated, and the tube system 105 is properly repositioned beneath the aerial vehicle 103 from a stored position that does not interfere with the takeoff or landing of the aerial vehicle 103. The tube system 105 may also have a support system located on the top of the aerial vehicle 103 during the takeoff/landing process. Alternatively, the sprinkler system 100 of the present invention may further comprise a wireless communication module 108 that enables the user (not shown) to release the water or other fire-suppressant material from the tank 103 through a mobile application 109 installed on the user's electronic device 110. The wireless communication module 108 can be a Wi-Fi/Bluetooth SoC embedded in the tank 301 or its valve, though the use of other wireless technologies is also contemplated including, but not limited to, RFID, NFC, 4G/5G/LTE, etc. Further, the wireless communication module 108 establishes a wireless connection with the electronic device 110, such as a smartphone, smart watch, tablet, computer, server, etc. This remote activation feature is particularly useful if the aerial vehicle 103 is, for example, an unmanned vehicle such as a drone. Additionally, the wireless communication module 108 and the system 100 as a whole are also capable of alerting the user with respect to, for example, how much water/fire suppressant material remains in the tank 301, how much has been dispensed by the system 100, the rate of the dispensing, etc. through one or more sensors 111 also positioned on the tank 301 and in electrical communication with the wireless communication module 108.

FIG. 2 illustrates a close-up perspective view of one potential embodiment of a sprinkler head 102 of the multipurpose water sprinkler system 100 of the present invention, wherein the sprinkler head 102 is designed to dispense water or other fire suppressant materials onto a fire in accordance with the disclosed architecture. As shown, the sprinkler head 102 is attached to the outermost pipe or tube 1051 that is in fluid communication with the tank 301. While FIG. 2 illustrates the sprinkler head 102 positioned on the outermost pipe or tube 1051, the same sprinkler head 102 structure and connection are equally applicable to each circular pipe of the pipe system 105, and the sprinkler heads 102 are preferably present on each of the tubes 1051, 1052, 1053, 1054.

As previously stated, water or other fire-suppressant materials flowing through the various pipes or tubing 1051, 1052, 1053, 1054 may be dispensed through the plurality of sprinkler heads 102 present along, and in fluid communication with, such tubing and onto a large, widespread forest fire, or field fire, or other affected areas. More specifically, the sprinkler head 102 has a threaded connection 201 with the tubing, wherein the threaded connection 201 is preferably either ½″ or ¾″ in diameter to match the diameter of the various tubes. The threaded connection 201 can be comprised of copper, brass, plastic or any other suitable fluid or material handling material that is relatively heat and corrosion resistant. The sprinkler head 102 has a frame 202 that is aligned with the pipe or tubing 1051. The frame 202 can be manufactured by a process called metal casing, wherein liquid metal takes shape as it cools inside a hollow mold. The frame 202 may also be comprised of copper, brass, plastic or any other suitable fluid or material handling material that is relatively heat and corrosion resistant.

In a preferred embodiment, the sprinkler head 102 further comprises a deflector plate 203. The deflector plate 203 causes the water or other fire-suppressant material to be dispersed with a relatively high pressure and in a generally downward direction over a large area such as, but not limited to, a forest, field or other affected area. The deflector plate 203 on the sprinkler head 102 distributes the water/fire-suppressant material effectively, and may be in the form of an upright, pendent or sidewall plate. The sprinkler head 102 is designed such that it has a relatively large K-factor, thereby allowing it to discharge more water/fire suppressant material at a relatively lower pressure and to produce bigger water/fire suppressant droplets that are more capable of penetrating fires. For example, the sprinkler head 102 can have a K factor in the range of 5.6-8.0 K. By way of background, the K-factor relates to the discharge rate from a nozzle, such as the sprinkler head 102. In one embodiment, the sprinkler head 102 is designed to provide either a solid stream or a fixed spray pattern of the water or fire suppressant material. The water/fire-suppressant material droplets dispensed from the sprinkler head 102 are preferably uniform in size and configuration, but are not required to be.

FIG. 3 illustrates a side perspective view of an aerial vehicle transporting one potential embodiment of the multipurpose water sprinkler system 100 of the present invention in accordance with the disclosed architecture. The multipurpose water sprinkler system 100 is designed to extinguish fires over a relatively large area, such as a forest fire, field fire or other type of fire. To provide water/fire suppressant materials for dispensing through the plurality of sprinkler heads 102, a water/fire suppressant tank 301 is placed inside or underneath the aerial vehicle 103. The tank 301 is in fluid communication with a primary pipeline 302 for supplying the water or other fire suppressant material from the tank 301 to each circular pipe or tubing of the tube system 105. The primary pipeline 302 runs between the water tank 301 and the tube system 105.

In this manner, the tank 301 is in fluid communication with each of the circular tubes 1051, 1052, 1053, 1054. From the main pipe, a plurality of pipes is connected to each of the circular tubes of the sprinkler tube system 105. The tank 301 further comprises an associated valve 303 that is designed to control the flow of water/fire suppressant material from the tank 301. The flow of the water/fire suppressant material can be controlled by an operator based on the level of the fire to be extinguished. For example, the pilot of the aerial vehicle 103 can easily control the flow of water/fire-suppressant from the tank 301 via the valve 303, or via the wireless communication module 108, mobile application 109 and electronic device 110 as described above. Once the valve 303 is open, the water/fire suppressant starts flowing through the primary pipeline 302 and is dispensed through one or more of the plurality of sprinklers head 102 onto a large, widespread forest fire or other affected area. The tank 301 can have a capacity of up to 1,000 gallons and can be placed within or beneath the helicopter or firefighter plane.

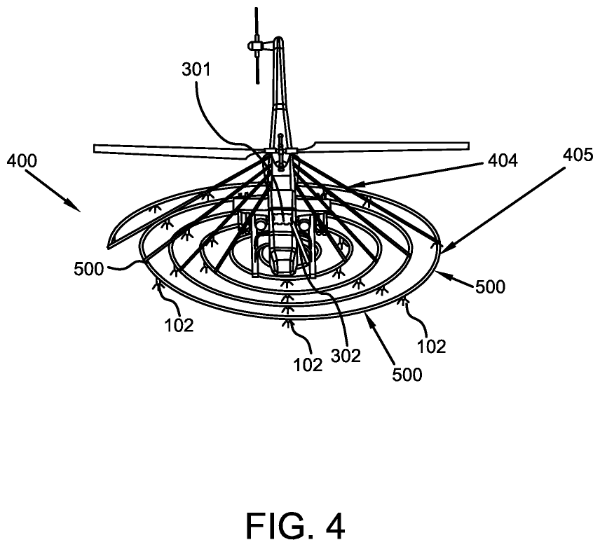

FIG. 4 illustrates a front perspective view of another embodiment of the multipurpose water sprinkler system 400 of the present invention in accordance with the disclosed architecture, wherein the system 400 comprises a spiral sprinkler design. As shown, the multipurpose water sprinkler system 400 has a spiral tube 405 connected to a main pipe 302 which is in fluid communication with the water tank 301. The tube system 105 has a single spiral tube having a plurality of sprinkler heads 102 positioned there along in a spaced-apart fashion. The spiral shape is symmetrical such that the aerial vehicle 103 lifting the multipurpose water sprinkler system 400 remains relatively stable, and the weight of the harness system 404 supporting the spiral tube system 405 is also uniformly supported and distributed. Like the other embodiments of the present invention, a valve 303 (shown in FIG. 3) to control flow of the water to the spiral tube 405 is present in the multipurpose water sprinkler system 400.

In one embodiment of the present invention, a water pressure gauge can also be present along with the valve 303 to allow a user to look at the pressure and accordingly control the flow of water/fire-suppressant material through the valve 303 and related piping/tubing. Each sprinkler head 102 of the present invention can preferably spray the water/fire-suppressant at pressures up to 600 psi, thereby acting as a high-pressure nozzle. The pipes 302 act as a conduit between the storage tank 301 and the plurality of sprinkler heads 102 and includes a control valve 303.

The sprinkler heads 102 together can deliver at least 200 gallons per minute to the ground. The sprinkler system 100 and 400 of the present invention can convert a simple aerial vehicle into a firefighting aerial vehicle. In one embodiment, the angle of the spray from the sprinkler heads 102 can be changed using a control, present in the aerial vehicle and connected electronically to the sprinkler system 100 and 400. Based on azimuth and elevation movements of the aerial vehicle 103, the sprinkler head's 102 direction can be automatically changed for effective delivery of water to the ground, or can be manually adjusted by an operator. A control system can automatically change the direction of the sprinkler head 102 deflector.

In another embodiment, the sprinkler system 100, 400 may further comprise one or more lights 500, such as LED lights, that can be used to allow the pilot or firefighter to better see the targeted area. The lights 500 may be attached to the system 100, 400 in several places such as, but not limited to, the harness system 404, the tubes 405, the sprinkler heads 102, etc. The plurality of lights 500 may also be repositionable either via the controls or the wireless communication module 108, mobile application 109 and electronic device 110.

The sprinkler system 100, 400 can be used to control and combat fires from relatively low elevations, while protecting both the operating crew and the sprinkler system 100 and 400 components. Nonetheless, the use of the sprinkler system 100, 400 is not so limited and, as stated above, can be used for a plurality of other purposes including, without limitation, recreation, irrigation of large fields with low water pressure, application or pesticides, etc.

Certain terms are used throughout the description and claims to refer to particular features or components. As one skilled in the art will appreciate, different persons may refer to the same feature or component by different names. This document does not intend to distinguish between components or features that differ in name but not structure or function. As used herein “multipurpose water sprinkler system”, “firefighting water spraying apparatus”, “water sprinkler system”, and “sprinkler system” are interchangeable and refer to the multipurpose water sprinkler system 100, 400 of the present invention.

Notwithstanding the forgoing, the multipurpose water sprinkler system 100, 400 of the present invention and their various components can be of any suitable size and configuration as is known in the art without affecting the overall concept of the invention, providing it accomplishes the above-stated objectives. One of ordinary skill in the art will appreciate that the size, configuration, and material of the multipurpose water sprinkler system 100, 400 as shown in the FIGS. are for illustrative purposes only, and that many other sizes and shapes of the multipurpose water sprinkler system 100, 400 are well within the scope of the present disclosure. Although the dimensions of the multipurpose water sprinkler system 100, 400 are important design parameters for user convenience, the multipurpose water sprinkler system 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner like the term “comprising” as “comprising” is interpreted when employed as a transitional word in a claim.

What is claimed is:

1. A multipurpose sprinkler system comprising:
a tube system having a top surface and a bottom surface;
a plurality of sprinkler heads positioned on the bottom surface of the tube system and in fluid communication with said tube system;
a harness system having a plurality of harnesses connected to the tube system and to an elevated structure;
a supply tank in fluid communication with the tube system via a connecting pipe; and
a valve for controlling a flow of a material from the supply tank to at least one of the plurality of sprinkler heads.

2. The multipurpose sprinkler system of claim 1, wherein the tube system is comprised of a plurality of concentric tubes.

3. The multipurpose sprinkler system of claim 2, wherein the plurality of concentric tubes decrease in diameter from an outermost one of the plurality of concentric tubes to an innermost one of the plurality of concentric tubes.

4. The multipurpose sprinkler system of claim 1, wherein the tube system is comprised of a single spiral tube.

5. The multipurpose sprinkler system of claim 1, wherein the plurality of sprinkler heads are directionally repositionable by an operator.

6. The multipurpose sprinkler system of claim 1, wherein the plurality of harnesses are repositionable via a control button.

7. The multipurpose water sprinkler system of claim 1, wherein the elevated structure is on an aerial vehicle.

8. The multipurpose sprinkler system of claim 1 further comprising a pressure gauge, at least one sensor and a wireless communication module.

9. The multipurpose sprinkler system of claim 8 further comprising a plurality of lights.

10. A firefighting spraying apparatus comprising:
a material storage tank positioned within or underneath an aerial vehicle;
a sprinkler tube system in fluid communication with the material storage tank;
a plurality of harnesses for supporting the sprinkler tube system from the aerial vehicle;
a plurality of sprinkler heads supported by, and in fluid communication with, the sprinkler tube system, wherein the plurality of sprinkler heads are directionally repositionable; and
a valve for controlling a flow of material from the material storage tank to the plurality of sprinkler heads.

11. The firefighting spraying apparatus of claim 10, wherein the sprinkler tube system is comprised of a plurality of concentric tubes.

12. The firefighting spraying apparatus of claim 11, wherein the plurality of concentric tubes decrease in diameter from an outermost one of the plurality of concentric tubes to an innermost one of the plurality of concentric tubes.

13. The firefighting spraying apparatus of claim 10, wherein the sprinkler tube system is comprised of a single spiral tube.

14. The firefighting spraying apparatus of claim 10, wherein the plurality of sprinkler heads are directionally repositionable by a remote operator using a mobile application on an electronic device.

15. The firefighting spraying apparatus of claim 10 further comprising a plurality of lights and a wireless communication module.

16. An aerial vehicle and multipurpose sprinkler combination comprising:
an aerial vehicle; and
a multipurpose sprinkler system, wherein the multipurpose sprinkler system is comprised of:
a material holding tank positioned within, or attached to, the aerial vehicle;
a sprinkler tube system having a top surface and a bottom surface;
a plurality of harnesses connecting the sprinkler tube system with the aerial vehicle;
a plurality of sprinkler heads positioned along the bottom surfaces of the tube system in a spaced apart fashion;
a connecting pipe in fluid communication with each of the material holding tank and the sprinkler tube system; and
a valve positioned along the connecting pipe.

17. The aerial vehicle and multipurpose sprinkler combination of claim 16, wherein the sprinkler tube system is comprised of a plurality of concentric tubes.

18. The aerial vehicle and multipurpose sprinkler combination of claim 17, wherein the plurality of concentric tubes decrease in diameter from an outermost one of the plurality of concentric tubes to an innermost one of the plurality of concentric tubes.

19. The aerial vehicle and multipurpose sprinkler combination of claim 16, wherein the sprinkler tube system is comprised of a single spiral tube.

20. The aerial vehicle and multipurpose sprinkler combination of claim 16 further comprising a plurality of lights.
